(19) United States
(12) Patent Application Publication
(10) Pub. No.: US 2020/0243931 A1
(43) Pub. Date: Jul. 30, 2020

(54) POWER STORAGE MODULE

(71) Applicant: HONDA MOTOR CO., LTD., Tokyo (JP)

(72) Inventor: Atsushi Sakurai, Wako-shi (JP)

(21) Appl. No.: 16/735,754

(22) Filed: Jan. 7, 2020

(30) Foreign Application Priority Data
Jan. 25, 2019 (JP) 2019-011531

(51) Int. Cl. H01M 10/6551; H01M 10/0585; H01M 10/04; H01M 10/613; H01M 2/10; H01M 2/34

(52) U.S. Cl. CPC H01M 10/6551; H01M 10/0585; H01M 2/348; H01M 10/613; H01M 2/1077; H01M 10/0413

(57) ABSTRACT

A power storage module includes: a plurality of battery cells stacked in one direction; and a battery case which houses the plurality of battery cells. The battery case includes: a case body which is formed in a tubular shape having a first orthogonal direction orthogonal to a stacking direction of the plurality of battery cells as an axial direction of the case body, and of which an inside is a housing space that houses the plurality of battery cells; and a plurality of cooling fins which protrude from an outer surface of the case body and are arranged to be spaced apart in the stacking direction. Protruding heights of the cooling fins become higher moving toward a center from both ends of the case body in the stacking direction.

### CROSS-REFERENCE TO RELATED APPLICATION

Priority is claimed on Japanese Patent Application No. 2019-011531, filed on Jan. 25, 2019, the contents of which are incorporated herein by reference.

### BACKGROUND

### Field of the Invention

The present invention relates to a power storage module.

### Background

Published Japanese Translation No. 2018-521447 of the PCT International Publication discloses a power storage module (battery) in which battery cell groups having a plurality of battery cells stacked therein are accommodated in a protective casing. Specifically, in the power storage module disclosed in Published Japanese Translation No. 2018-521447 of the PCT International Publication, a plurality of battery cell groups are respectively accommodated in a plurality of internal pockets of the protective casing arranged in a stacking direction of the battery cells. Partition walls of the protective casing that define the internal pockets are positioned between adjacent battery cell groups in the stacking direction of the battery cells.

### SUMMARY

In a power storage module including a plurality of battery cells stacked in one direction, each battery cell generates heat as it is charged and discharged. However, heat generated in a battery cell positioned in a central portion or in the vicinity thereof in the stacking direction of the plurality of battery cells is not easily dissipated outside. In addition, performance deterioration tends to be accelerated in a battery cell whose temperature has risen, but it is possible to inhibit performance deterioration of a power storage module by uniformly inhibiting temperature increase.

An object of an aspect of the present invention is to provide a power storage module in which heat dissipation characteristics of a plurality of stacked battery cells can be improved.

(1) A power storage module according to one aspect of the present invention includes: a plurality of battery cells stacked in one direction; and a battery case which houses the plurality of battery cells, in which the battery case includes: a case body which is formed in a tubular shape having a first orthogonal direction orthogonal to a stacking direction of the plurality of battery cells as an axial direction of the case body, and of which an inside is a housing space that houses the plurality of battery cells; and a plurality of cooling fins which protrude from an outer surface of the case body and are arranged to be spaced apart in the stacking direction, and protruding heights of the cooling fins become higher moving toward a center from both ends of the case body in the stacking direction.

(2) A power storage module according to another aspect of the present invention includes: a plurality of battery cells stacked in one direction; and a battery case which houses the plurality of battery cells, in which the battery case includes: a case body which is formed in a tubular shape having a first orthogonal direction orthogonal to a stacking direction of the plurality of battery cells as an axial direction of the case body, and of which an inside is a housing space that houses the plurality of battery cells; and a plurality of cooling fins which protrude from an outer surface of the case body and are arranged to be spaced apart in the stacking direction, and intervals between the cooling fins adjacent to each other in the stacking direction become smaller moving toward a center from both ends of the case body in the stacking direction.

(3) In the power storage module, the case body may be formed in a rectangular tubular shape having a pair of first side walls disposed to be spaced apart in the stacking direction and a pair of second side walls disposed to be spaced apart in a second orthogonal direction orthogonal to the stacking direction and the first orthogonal direction, and the plurality of cooling fins may protrude from each of outer surfaces of the pair of second side walls and may be arranged in the stacking direction on each of the pair of second side walls.

(4) In the power storage module, the battery case may further include a partition wall which is connected to an inner surface of the case body and partitions the housing space into a plurality of separate spaces arranged in the stacking direction, the partition wall may be disposed in a central portion of the case body in the stacking direction, and at least one cooling fin of the plurality of cooling fins arranged in the stacking direction may overlap the partition wall in a second orthogonal direction orthogonal to the stacking direction and the first orthogonal direction.

(5) In the power storage module, the partition wall may be formed to extend in the second orthogonal direction, both ends of the partition wall in the second orthogonal direction may be connected to the inner surface of the case body, and a protruding height of the one cooling fin overlapping the partition wall may be higher than a protruding height of another cooling fin adjacent to the one cooling fin in the stacking direction.

(6) In the power storage module, the battery case may further include a partition wall which is connected to an inner surface of the case body and partitions the housing space into a plurality of separate spaces arranged in the stacking direction, the partition wall may be formed to extend in a second orthogonal direction orthogonal to the stacking direction and the first orthogonal direction, both ends of the partition wall in the second orthogonal direction may be connected to an inner surface of the case body, and a thickness of the cooling fin in the stacking direction may be smaller than a thickness of the partition wall in the stacking direction.

(7) In the power storage module, the case body may be formed in a square tubular shape having a pair of first side walls disposed to be spaced apart in the stacking direction and a pair of second side walls disposed to be spaced apart in a second orthogonal direction orthogonal to the stacking direction and the first orthogonal direction, an inner surface of the first side wall facing an inside of the case body may be formed to be a flat surface orthogonal to the stacking direction, an inner surface of the second side wall facing an inside of the case body may be formed to be a flat surface orthogonal to the second orthogonal direction, the plurality of cooling fins may protrude from each of outer surfaces of the pair of second side walls, and a thickness in the second orthogonal direction obtained by summing thicknesses of the second side wall and the cooling fin provided on the second side wall may be equal to or less than a thickness of the first side wall in the stacking direction.

According to the above aspect (1), a surface area of one cooling fin positioned at the center of the case body in the stacking direction of the battery cells is larger than a surface area of another cooling fin. Thus, heat generated in the battery cells housed in the central portion of the housing space in the stacking direction can be efficiently transmitted to the one cooling fin. As a result, the heat of the battery cells positioned in the central portion can be effectively dissipated outside the case body. Therefore, heat dissipation characteristics of the plurality of stacked battery cells can be improved.

According to the above aspect (2), the cooling fins are densely disposed in the central portion of the case body in the stacking direction of the battery cells. Thus, heat generated in the battery cells housed in the central portion of the housing space in the stacking direction can be efficiently transmitted to the plurality of densely disposed cooling fins. As a result, the heat of the battery cells positioned in the central portion can be effectively dissipated outside the case body. Therefore, heat dissipation characteristics of the plurality of stacked battery cells can be improved.

According to the above aspect (3), heat of the battery cells positioned in the central portion of the housing space in the stacking direction is mainly transmitted from the second side walls to the cooling fins. On the other hand, heat of the battery cells positioned in both end portions of the housing space is mainly transmitted to the first side walls. That is, the heat of the battery cells positioned in the central portion and the heat of the battery cells positioned in both end portions can be transmitted to different portions of the case body. Therefore, heat dissipation characteristics of the plurality of stacked battery cells can be effectively improved.

According to the above aspect (4), by providing the partition wall at a position overlapping a cooling fin, heat generated in the battery cells housed in the central portion of the housing space in the stacking direction can be efficiently transmitted to the cooling fin through the partition wall. As a result, the heat of the battery cells positioned in the central portion of the housing space can be effectively dissipated outside the case body. Therefore, heat dissipation characteristics of the plurality of stacked battery cells can be further improved.

According to the above aspect (5), the protruding height of one cooling fin which overlaps the partition wall is higher than the protruding height of other adjacent cooling fins. For this reason, heat of the battery cells is easily transmitted to the one cooling fin having a large surface area. As a result, the heat of the battery cells can be more effectively dissipated outside the case body. Therefore, heat dissipation characteristics of the plurality of battery cells can be further improved.

Moreover, according to the above aspect (5), when the case body hits an object (for example, the ground) or the like, the one cooling fin of the plurality of cooling fins which overlaps the partition wall tends to come into contact with the object in advance of the other cooling fins. For this reason, an external force such as an impact and a load which acts on the one cooling fin can be directly transmitted to the partition wall. That is, the external force which acts on the one cooling fin can be inhibited from being transmitted to wall portions of the case body. As a result, deformation of the wall portions of the case body due to the external force can be inhibited.

According to the above aspect (6), thicknesses of the cooling fins are smaller than the thickness of the partition wall. For this reason, when the case body hits an object or the like and thus an external force such as an impact or a load acts on the cooling fins, the cooling fins are damaged or deformed in advance of the partition wall. As a result, the external force is absorbed by the cooling fins, and breakage and deformation of the partition wall can be inhibited. That is, the partition wall can be protected.

According to the above aspect (7), even if a direction in which the power storage module is inserted into slots of various electrical devices is rotated by 90 degrees about an axis of the case body, the power storage module can be inserted into the slots. Therefore, the power storage module can be easily handled.

### BRIEF DESCRIPTION OF THE DRAWINGS

FIG. 1 is a perspective view of a power storage module according to an embodiment of the present invention when viewed from a first lid portion side.

FIG. 2 is a perspective view of the power storage module of the embodiment when viewed from a second lid portion side.

FIG. 3 is an exploded perspective view showing a state in which a pair of lid portions are separated from a case body in the power storage module of the embodiment.

FIG. 4 is an exploded perspective view showing a state in which a plurality of battery cells are taken out from the case body in the power storage module of the embodiment.

FIG. 5 is a plan view of the case body when viewed in an axial direction thereof in the power storage module of the embodiment.

FIG. 6 is a cross-sectional view taken along line VI-VI of FIG. 5.

### DESCRIPTION OF EMBODIMENTS

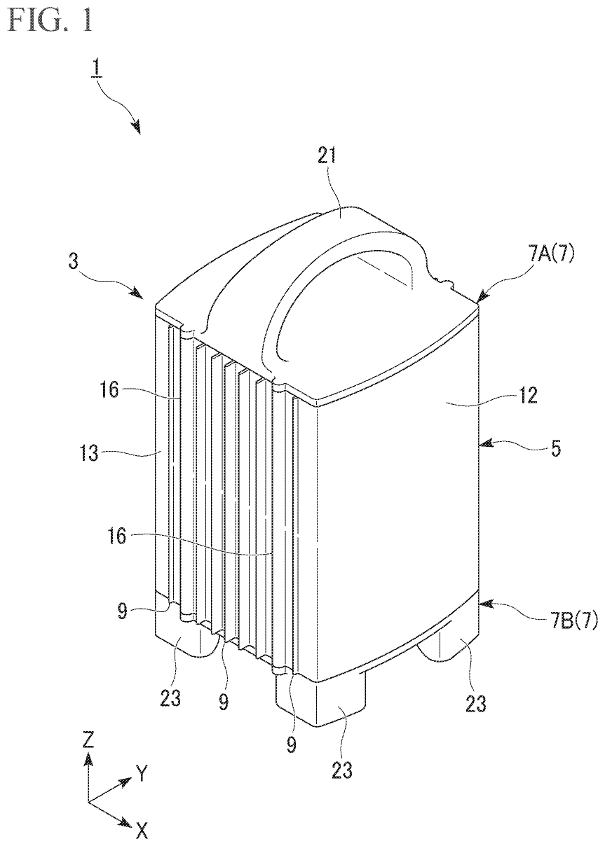

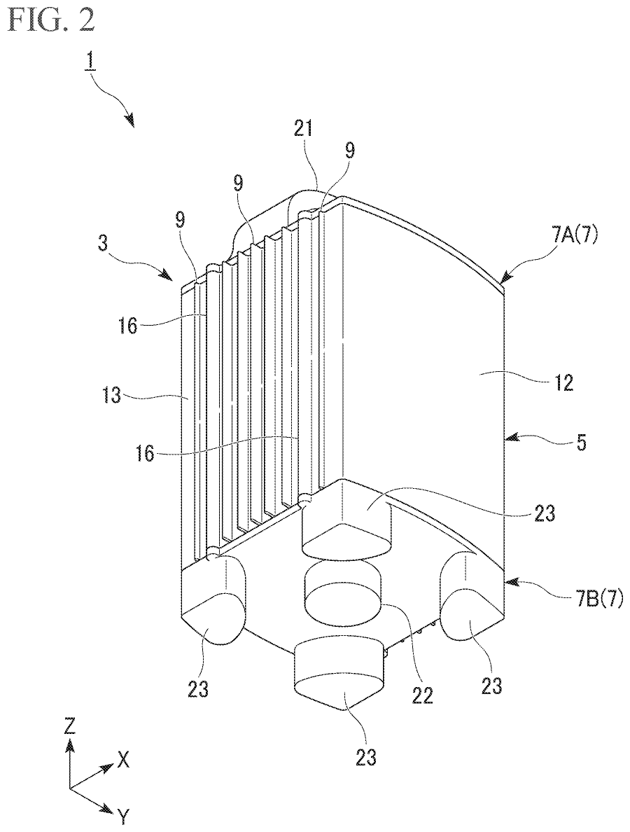

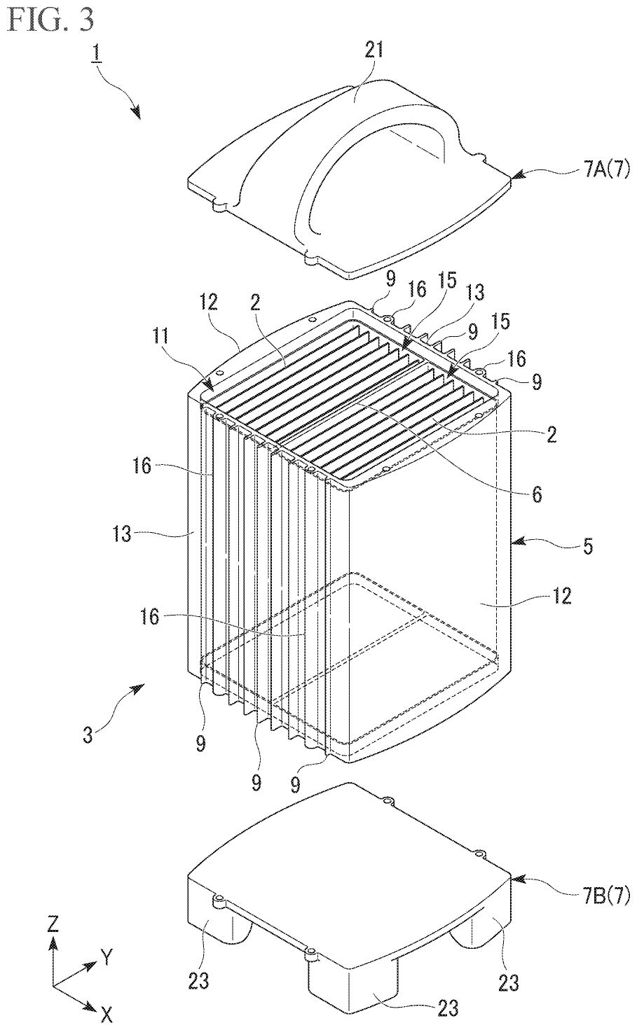

Hereinafter, one embodiment of the present invention will be described with reference to FIGS. 1 to 6.

As shown in FIGS. 1 to 3, a power storage module 1 according to the present embodiment includes a plurality of battery cells 2 stacked in one direction, and a battery case 3 which houses the plurality of battery cells 2.

In FIGS. 1 to 6, the X-axis direction indicates a stacking direction of the plurality of battery cells 2, the Z-axis direction indicates a first orthogonal direction orthogonal to the stacking direction, and the Y-axis direction indicates a second orthogonal direction orthogonal to the stacking direction and the first orthogonal direction.

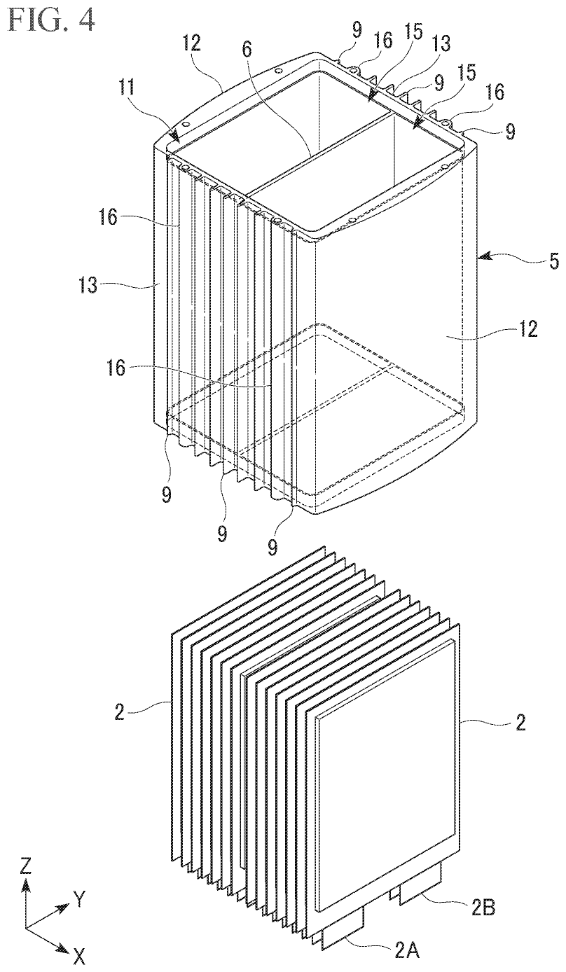

A shape of the battery cell 2 is arbitrary. As shown in FIGS. 4 to 6, the battery cell 2 of the present embodiment is formed in a plate shape in which a thickness direction thereof is the stacking direction (X-axis direction). Specifically, the battery cell 2 is a laminate type battery cell 2 in which a pair of films are laminated as battery elements. The laminate type battery cell 2 may expand in the thickness direction (stacking direction) at the time of charging and discharging, heat generation, or performance degradation.

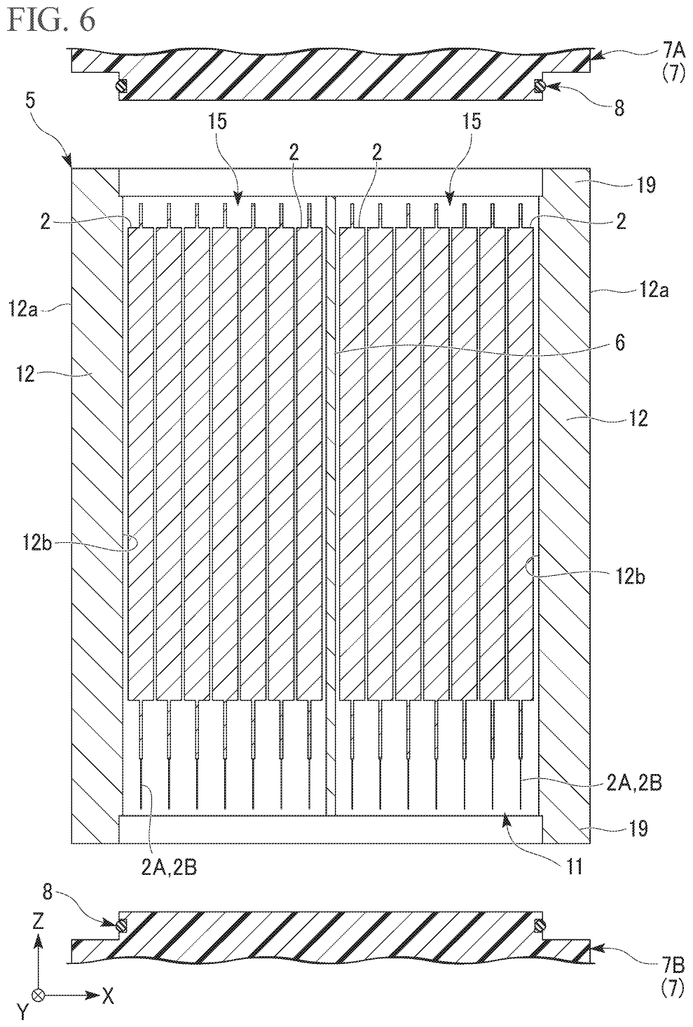

As shown in FIGS. 4 and 6, the plurality of battery cells 2 are stacked such that electrodes 2A and 2B of each battery cell 2 are positioned on one side in the first orthogonal direction (a negative direction side of the Z-axis). The plurality of battery cells 2 are electrically connected in series or in parallel by appropriately connecting the electrodes 2A and 2B using a bus bar or a circuit board (not shown).

As shown in FIGS. 1 to 6, the battery case 3 includes a case body 5 and a plurality of cooling fins 9. The battery case 3 further includes a partition wall 6 and a pair of lid portions 7.

As shown in FIGS. 4 to 6, the case body 5 is formed in a tubular shape having the first orthogonal direction (Z-axis direction) as an axial direction thereof. An inside of the case body 5 is a housing space 11 for housing the plurality of battery cells 2. The plurality of battery cells 2 are disposed in the housing space 11 while being arranged in a direction orthogonal to the axial direction of the case body 5.

The case body 5 is formed in an arbitrary tubular shape such as a cylindrical shape. The case body 5 of the present embodiment is formed in a rectangular tubular shape having a pair of first side walls 12 and a pair of second side walls 13.

The pair of first side walls 12 are disposed to be spaced apart in the stacking direction (X-axis direction) of the plurality of battery cells 2. That is, the pair of first side walls 12 are positioned on both sides of the plurality of battery cells 2 housed in the housing space 11 in the stacking direction. The pair of second side walls 13 are disposed to be spaced apart in the second orthogonal direction (Y-axis direction).

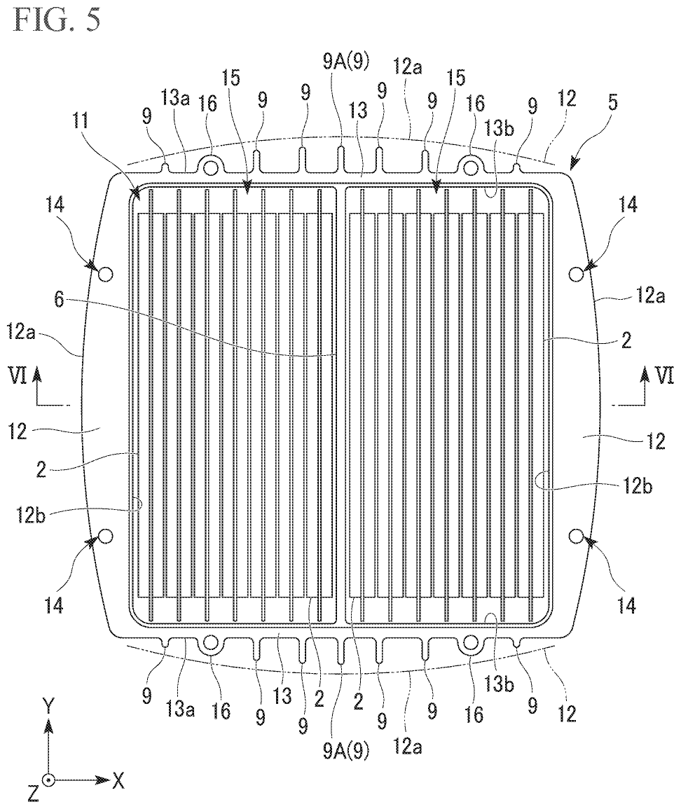

As shown in FIGS. 4 and 5, the first side wall 12 extends in the first and second orthogonal directions and is formed in a plate shape having the stacking direction as a thickness direction thereof. The first side wall 12 may be formed in a flat plate shape, for example. The first side wall 12 of the present embodiment is formed to swell outward in the case body 5.

As shown in FIG. 5, an outer surface 12a of the first side wall 12 which faces outward from the case body 5 in the stacking direction is obliquely formed to advance further outward in the case body 5 in the stacking direction moving toward a center from both ends of the first side wall 12 in the second orthogonal direction. Specifically, the outer surface 12a of the first side wall 12 is formed in an arc shape in which a center of the outer surface 12a in the second orthogonal direction protrudes further outward in the case body 5 in the stacking direction than both ends of the outer surface 12a. On the other hand, an inner surface 12b of the first side wall 12 facing inward from the case body 5 in the stacking direction is formed to be a flat surface orthogonal to the stacking direction. Thus, a thickness of the first side wall 12 in the stacking direction becomes thicker moving toward the center from both ends of the first side wall 12 in the second orthogonal direction.

Through holes 14 penetrating in the first orthogonal direction are formed in each first side wall 12. A plurality of (two in the illustrated example) through holes 14 are arranged at intervals in the second orthogonal direction on each first side wall 12. Screws (not shown) for fixing the lid portion 7 (a component), which will be described later, to the case body 5 pass through the through holes 14. For example, female screws engaging with the screws may be formed on inner circumferences of the through holes 14.

The through holes 14 may be formed in a region excluding both ends of the first side wall 12 having smaller thicknesses than the other portions of the first side wall 12. Thus, a decrease in rigidity of the first side wall 12 accompanying formation of the through holes 14 can be inhibited.

As shown in FIGS. 4 and 5, each second side wall 13 is formed in a plate shape extending in the stacking direction and the first orthogonal direction and having the second orthogonal direction as a thickness direction thereof. The second side wall 13 of the present embodiment is formed in a flat plate shape. That is, an outer surface 13a of the second side wall 13 facing outward from the case body 5 and an inner surface 13b of the second side wall 13 facing inward from the case body 5 are formed to be flat surfaces orthogonal to the second orthogonal direction.

For example, the pair of first side walls 12 and the pair of second side walls 13 described above may be formed separately and then fixed to each other. In the present embodiment, the pair of first side walls 12 and the pair of second side walls 13 are integrally formed.

In the case body 5 of the present embodiment, a length of the first side wall 12 in the second orthogonal direction and a length of the second side wall 13 in the stacking direction are equal to each other. That is, the case body of the present embodiment is formed in a square tubular shape.

As shown in FIGS. 4 and 5, the plurality of cooling fins 9 protrude from outer surfaces of the case body 5 and are arranged at intervals in the stacking direction (X-axis direction). The cooling fins 9 are formed integrally with the case body 5. The cooling fins 9 protrude from the outer surfaces of the case body 5 in the second orthogonal direction (Y-axis direction).

As shown in FIG. 5, protruding heights of the cooling fins 9 become higher moving toward a center from both ends of the case body 5 in the stacking direction. That is, among the plurality of cooling fins 9 arranged in the stacking direction, a protruding height of a cooling fin 9A positioned in a central portion of the case body 5 in the stacking direction is the highest, and protruding heights of cooling fins 9 positioned in both end portions of the case body 5 are the lowest. In the present embodiment, the cooling fin 9A positioned in the central portion is positioned in the middle of the housing space 11 in the stacking direction. Also, the cooling fin 9A positioned in the central portion may be positioned, for example, deviated from the middle of the housing space 11 in the stacking direction.

Further, intervals (pitches) between the cooling fins 9 adjacent to each other in the stacking direction become smaller moving toward the center from both ends in the stacking direction. That is, in the stacking direction, an interval between the cooling fins 9 in the central portion of the case body 5 is the smallest, and intervals between the cooling fins 9 in both end portions of the case body 5 are the largest.

In the present embodiment, the plurality of cooling fins 9 protrude from outer surfaces 13a of the pair of second side walls 13 in the second orthogonal direction. Also, the plurality of cooling fins 9 are arranged in the stacking direction on each of the outer surfaces 13a of the pair of second side walls 13. The cooling fins 9 positioned in both end portions of the second side walls 13 in the stacking direction may be positioned inward in the case body 5 with respect to the inner surfaces 12b of the pair of first side walls 12 as shown in the illustrated example, and the cooling fins 9 may be positioned outward in the case body 5 with respect to the inner surfaces 12b of the first side walls 12, for example.

As shown in FIGS. 4 and 5, the cooling fins 9 of the present embodiment are formed in plate shapes extending in the first orthogonal direction and the second orthogonal direction and having the stacking direction as a thickness direction of the plate. Also, the cooling fins 9 extend linearly from one end to the other end of the second side wall 13 in the first orthogonal direction. Thicknesses of the plurality of cooling fins 9 arranged in the stacking direction may be different from each other, for example, but are equal to each other in the present embodiment.

Further, in the present embodiment, as shown in FIG. 5, a thickness in the second orthogonal direction obtained by combining those of the second side wall 13 and the cooling fin 9 provided on the second side wall 13 is formed to be equal to or less than a thickness of the first side wall 12 in the stacking direction. That is, the protruding height of the cooling fin 9 is set such that a total thickness of the second side wall 13 and the cooling fin 9 is equal to or less than the thickness of the first side wall 12. In other words, when the case body 5 is viewed in the first orthogonal direction (the axial direction of the case body 5), tips of the cooling fins 9 in a protruding direction thereof are positioned inward in the case body 5 with respect to the outer surfaces 12a of the first side walls 12 (the outer surfaces 12a of the first side walls 12 indicated by two-dot dashed lines in FIG. 5) when the case body 5 is rotated 90 degrees about an axis thereof.

In addition, in the present embodiment, the protruding heights of the cooling fins 9 protruding from the same second side wall 13 become higher moving toward the center from both ends of the case body 5 in the stacking direction.

For this reason, a line (curve) connecting the tips of the plurality of cooling fins 9 in the protruding direction which are arranged in the stacking direction on the same second side wall 13 conforms to the outer surface 12a of the first side wall 12 formed in an arc shape. Also, the line connecting the tips of the plurality of cooling fins 9 is positioned inward from the outer surface 12a of the first side wall 12 when the case body 5 is rotated 90 degrees.

As shown in FIGS. 4 and 5, boss portions 16 protruding from the outer surfaces 13a of the second side walls 13 are formed on each second side wall 13 of the case body 5 in addition to the cooling fins 9 described above. The boss portion 16 is formed in a cylindrical shape extending linearly from one end to the other end of the second side wall 13 in the first orthogonal direction. A screw (not shown) for fixing the lid portion 7, which will be described later, to the case body 5 passes through the boss portion 16. For example, a female screw engaging with the screw may be formed on an inner circumference of the boss portion 16.

In the present embodiment, two boss portions 16 are arranged to be spaced apart from each other in the stacking direction. Also, each boss portion 16 is disposed between the cooling fins 9 adjacent to each other in the stacking direction in both end portions of the second side wall 13 in the stacking direction.

As shown in FIG. 5, similarly to the cooling fin 9 described above, a protruding height of the boss portion 16 in the second orthogonal direction is set such that a thickness obtained by combining those of the second side wall 13 and the boss portion 16 in the second orthogonal direction is equal to or less than the thickness of the first side wall 12 in the stacking direction. That is, a tip of the boss portion 16 in the protruding direction is positioned inward in the case body 5 with respect to the outer surface 12a of the first side wall 12 when the case body 5 is rotated 90 degrees about its axis.

As shown in FIGS. 4 to 6, the partition wall 6 is connected to inner surfaces of the case body 5 and partitions the housing space 11 of the case body 5 into a plurality of separate spaces 15 arranged in the stacking direction (X-axis direction). In the present embodiment, the number of partition wall 6 is one, and the number of separate spaces 15 is two.

The partition wall 6 of the present embodiment is disposed in the central portion of the case body 5 in the stacking direction.

Specifically, the partition wall 6 is disposed in the middle of the housing space 11 in the stacking direction. For this reason, lengths of the two separate spaces 15 in the stacking direction are equal to each other. Also, the partition wall 6 may be positioned, for example, deviated from the middle of the housing space 11 in the stacking direction, but is more preferably positioned in the vicinity of the middle of the housing space 11 (that is, the central portion).

As shown in FIGS. 4 to 6, the partition wall 6 of the present embodiment is formed in a flat plate shape extending in the first orthogonal direction and the second orthogonal direction and having the stacking direction as a thickness direction of the plate. Both ends of the partition wall 6 in the second orthogonal direction are connected to the inner surfaces of the case body 5. Specifically, both ends of the partition wall 6 are connected to the pair of second side walls 13. For example, the partition wall 6 may be formed separately from the case body 5 and then attached to the case body 5. The partition wall 6 of the present embodiment is formed integrally with the case body 5.

The thickness of the partition wall 6 in the stacking direction may be equal to or less than the thicknesses of the cooling fins 9 in the stacking direction, for example. As shown in FIG. 5, the thickness of the partition wall 6 in the present embodiment is larger than the thicknesses of the cooling fins 9.

The partition wall 6 overlaps one cooling fin 9 in the second orthogonal direction (thickness direction of the second side wall 13) among the plurality of cooling fins 9 arranged in the stacking direction. In the present embodiment, the partition wall 6 overlaps the cooling fin 9A positioned in the middle of the housing space 11 in the stacking direction. The cooling fin 9A may be disposed to partially or entirely overlap the partition wall 6. The center of the cooling fin 9A in the stacking direction may coincide with a center of the partition wall 6 in the stacking direction as in the illustrated example, and may be deviated from the center of the partition wall 6 in the stacking direction, for example.

Also, a protruding height of the cooling fin 9A overlapping the partition wall 6 is higher than a protruding heights of other cooling fins 9 adjacent to the cooling fin 9A in the stacking direction.

The case body 5, the cooling fins 9, and the partition wall 6 configured as described above may be formed of a material having high thermal conductivity such as aluminum. The case body 5, the cooling fins 9, and the partition wall 6 can be integrally manufactured by extrusion molding.

As shown in FIGS. 1 to 3, the pair of lid portions 7 cover openings at both ends of the case body 5 in the first orthogonal direction (the axial direction of the case body 5). The pair of lid portions 7 are detachably attached to the case body 5 by screwing or the like. Each lid portion 7 is formed in a rectangular shape corresponding to the case body 5 when viewed in the first orthogonal direction.

A first lid portion 7A of the pair of lid portions 7 is provided with a grip portion 21 for carrying the power storage module 1. The grip portion 21 is formed in a curved bar shape or a band plate shape. Both ends of the grip portion 21 are connected to an outer surface of the first lid portion 7A facing outward from the case body 5. Since the power storage module 1 includes the grip portion 21, the power storage module 1 can be used as a portable power storage module.

In the present embodiment, the first lid portion 7A including the grip portion 21 is made of a resin having a lower thermal conductivity than that of the case body 5.

A second lid portion 7B of the pair of lid portions 7 is provided with a connector 22 and a plurality of leg portions 23.

The connector 22 electrically connects the power storage module 1 (the plurality of battery cells 2) to external devices. The connector 22 protrudes from an outer surface of the second lid portion 7B facing outward from the case body 5. The connector 22 is formed in a cylindrical shape and is disposed at a position centered on the axis of the case body 5. That is, the connector 22 is formed in an axially symmetric shape and is disposed at a position that is axially symmetric with respect to the case body 5.

The plurality of leg portions 23 protrude from the outer surface of the second lid portion 7B in the same manner as the connector 22. Protruding heights of the leg portions 23 with respect to the outer surface of the second lid portion 7B are greater than a protruding height of the connector 22. The plurality of leg portions 23 are arranged to surround the connector 22. Specifically, the plurality of leg portions 23 are disposed at four corners of the outer surface of the second lid portion 7B formed in a rectangular shape. By providing the plurality of leg portions 23, it is possible to prevent the connector 22 from coming into contact with the ground or the like in a state in which the power storage module 1 is placed on the ground or the like with the second lid portion 7B placed downward in a vertical direction.

In the present embodiment, like the first lid portion 7A, the second lid portion 7B including the leg portions 23 is made of a resin having a lower thermal conductivity than that of the case body 5.

As shown in FIG. 6, the battery case 3 of the present embodiment further includes seal portions 8 which fill gaps between end portions of the openings 19 of the case body 5 and the lid portions 7. The seal portions 8 prevent moisture from entering the inside of the case body 5 from the gaps between the case body 5 and the lid portions 7.

The seal portion 8 in the illustrated example is a shaft seal which is provided between an inner circumference of the case body 5 at the end portion of each opening 19 and an outer circumference of an insertion portion of each lid portion 7 inserted inside the end portion of each opening 19 of the case body 5. Also, the seal portion 8 may be, for example, a flat seal which is provided between each end surface of the case body 5 facing outward from the case body 5 in the first orthogonal direction and each opposing surface of the lid portions 7 opposite to the end surface.

As described above, according to the power storage module 1 of the present embodiment, the plurality of cooling fins 9 protrude from the outer surfaces of the case body 5 and are arranged at intervals in the stacking direction. In addition, the protrusion heights of the cooling fins 9 become higher moving toward the center from both ends of the case body 5 in the stacking direction. For this reason, the surface area of one cooling fin 9A positioned at the center of the case body 5 among the plurality of cooling fins 9 is larger than the surface areas of other cooling fins 9.

Thus, heat generated in the battery cells 2 housed in the central portion of the housing space 11 in the stacking direction can be efficiently transmitted to the one cooling fin 9A. As a result, the heat of the battery cells 2 positioned in the central portion can be effectively dissipated outside the case body 5. Therefore, heat dissipation characteristics of the plurality of stacked battery cells 2 can be improved.

Also, according to the power storage module 1 of the present embodiment, the intervals between the cooling fins 9 adjacent to each other in the stacking direction become smaller moving toward the center from both ends of the case body 5 in the stacking direction. For this reason, the cooling fins 9 are densely disposed in the central portion of the case body 5 in the stacking direction. Thus, the heat generated in the battery cells 2 housed in the central portion of the housing space 11 in the stacking direction can be efficiently transmitted to the plurality of densely disposed cooling fins 9. As a result, the heat of the battery cells 2 positioned in the central portion can be effectively dissipated outside the case body 5. Therefore, heat dissipation characteristics of the plurality of stacked battery cells 2 can be improved.

Also, the power storage module 1 of the present embodiment is formed in the rectangular tubular shape having the pair of first side walls 12 arranged in the stacking direction and the pair of second side walls 13 arranged in the second orthogonal direction. In addition, the plurality of cooling fins 9 are respectively provided on the pair of second side walls 13 extending in the stacking direction. For this reason, the heat of the battery cells 2 positioned in the central portion of the housing space 11 in the stacking direction is mainly transmitted from the second side walls 13 to the cooling fins 9. On the other hand, the heat of the battery cells 2 positioned in both end portions of the housing space 11 is mainly transmitted to the first side walls 12. That is, the heat of the battery cells 2 positioned in the central portion and the heat of the battery cells 2 positioned in both end portions can be transmitted to different portions of the case body 5. Therefore, heat dissipation characteristics of the plurality of stacked battery cells 2 can be effectively improved.

Also, according to the power storage module 1 of the present embodiment, the partition wall 6 is disposed in the central portion of the case body 5 in the stacking direction. In addition, the one cooling fin 9A disposed in the central portion of the case body 5 overlaps the partition wall 6 in the thickness direction of the second side walls 13 (wall portions of the case body 5). For this reason, the heat generated in the battery cells 2 housed in the central portion of the housing space 11 can be efficiently transmitted to the one cooling fin 9 through the partition wall 6. As a result, the heat of the battery cells 2 positioned in the central portion of the housing space 11 can be effectively dissipated outside the case body 5. Therefore, heat dissipation characteristics of the plurality of stacked battery cells 2 can be further improved.

Also, according to the power storage module 1 of the present embodiment, the protruding height of the one cooling fin 9A overlapping the partition wall 6 is higher than the protruding heights of other cooling fins 9 adjacent thereto. For this reason, the heat of the battery cells 2 is easily transmitted to the one cooling fin 9A having a large surface area. As a result, the heat of the battery cells 2 can be more effectively dissipated outside the case body 5. Therefore, heat dissipation characteristics of the plurality of battery cells 2 can be further improved.

Also, since the protruding height of the one cooling fin 9A overlapping the partition wall 6 is higher than the protruding heights of other cooling fins 9, the one cooling fin 9A overlapping the partition wall 6 among the plurality of cooling fins 9 easily comes into contact with an object in advance of the other cooling fins 9 when the case body 5 collides with the object (for example, the ground). For this reason, an external force such as an impact or a load acting on the one cooling fin 9A can be directly transmitted to the partition wall 6. That is, the external force acting on the one cooling fin 9A can be inhibited from being transmitted to the second side walls 13 (wall portions of the case body 5). As a result, deformation of the second side walls 13 due to the external force can be inhibited. Inhibiting the deformation of the wall portions of the case body 5 is effective in that occurrence of a malfunction in functions (charging and discharging) of the power storage module 1 when the battery cells 2 move or deform in the case body 5 with the deformation of the wall portions of the case body 5 can be inhibited.

Also, according to the power storage module 1 of the present embodiment, the thicknesses of the cooling fins 9 are smaller than the thickness of the partition wall 6. For this reason, when the case body 5 collides with an object and thus an external force such as an impact or a load acts on the cooling fins 9, the cooling fins 9 are damaged or deformed in advance of the partition wall 6. Thus, the external force is absorbed in the cooling fins 9, and breakage and deformation of the partition wall 6 can be inhibited. That is, the partition wall 6 can be protected.

Also, according to the power storage module 1 of the present embodiment, the case body 5 is formed in a square tubular shape having the pair of first side walls 12 and the pair of second side walls 13. In addition, the total thickness of the cooling fin 9 and the second side wall 13 is smaller than the thickness of the first side wall 12. For this reason, even if the direction in which the power storage module 1 is inserted into slots of various electrical devices is rotated 90 degrees about the axis of the case body 5, the power storage module 1 can be inserted into the slots. Therefore, the power storage module 1 can be easily handled.

Also, according to the power storage module 1 of the present embodiment, the thickness of the first side wall 12 becomes thicker moving toward the center from both ends of the first side wall 12 in the second orthogonal direction. For this reason, even if an external force such as an impact or a load acts on the first side wall 12 from the outside of the case body 5, it is possible to inhibit the first side wall 12 from being deformed (particularly, deformed to be bent). In particular, since the outer surface 12a of the first side wall 12 is formed in an arc shape protruding outward in the case body 5, deformation of the first side wall 12 due to the external force from the outside of the case body 5 can be effectively inhibited.

Also, even if the first side wall 12 is pushed from the inside of the case body 5 due to an expansion force of the battery cells 2 accompanying charging and discharging, heat generation, and performance deterioration, deformation (particularly, bending deformation) of the first side wall 12 may be inhibited. More specifically, when a force from the inside of the case body 5 acts on the first side wall 12, a bending moment in the first side wall 12 becomes the largest in the central portion of the first side wall 12 in the second orthogonal direction. On the other hand, in the power storage module 1 of the present embodiment, by forming the central portion of the first side wall 12 in the second orthogonal direction to be thicker, a geometrical moment of inertia of the central portion of the first side wall 12 increases. As a result, deformation (especially, bending deformation) of the first side wall 12 can be effectively inhibited.

Also, since the thickness of the first side wall 12 in the stacking direction becomes thinner in both end portions of the first side wall 12 in the second orthogonal direction, a material used for the first side wall 12 can be reduced while inhibiting deformation of the first side wall 12. Thus, reduction in weight and reduction in manufacturing cost of the power storage module 1 including the first side walls 12 can be achieved.

Also, according to the power storage module 1 of the present embodiment, the boss portion 16 through which a screw passes in order to fix the lid portion 7 to the case body 5 protrudes from the outer surface 13a of the second side wall 13. For this reason, as compared with the case in which a hole through which a screw pass is formed in the second side wall 13, the thickness of the second side wall 13 can be reduced to be small, while securing a rigidity of the second side wall 13. Thus, the material used for the second side wall 13 can be reduced. Therefore, reduction in weight and reduction in manufacturing cost of the power storage module 1 including the second side walls 13 can be achieved.

Also, according to the power storage module 1 of the present embodiment, the four wall portions (the pair of first side walls 12 and the pair of second side walls 13) constituting the case body 5 are integrally formed. In this configuration, since there is no seams at boundaries between the four wall portions, it is possible to reduce locations through which moisture enters the case body 5. That is, it is possible to reduce the number of seal portions that close the seams in order to prevent moisture from entering the inside of the case body 5, thereby simplifying a seal structure of the battery case 3.

Also, according to the power storage module 1 of the present embodiment, the rigidity of the case body 5 can be improved by integrally forming the four wall portions constituting the case body 5. Thus, deformation of these wall portions can be inhibited even when an external force such as an impact or a load acts on the wall portions of the case body 5 from the outside of the case body 5, or the wall portions of the case body 5 are pushed from the inside of the case body 5 as the battery cells 2 expand. In particular, occurrence of a gap between the case body 5 and the lid portions 7 (occurrence of a state in which the seal portions 8 do not function) accompanying deformation of the end portion of the openings 19 of the case body 5 can be effectively inhibited. That is, sealing performance of the battery case 3 can be effectively inhibited from being impaired.

Also, according to the power storage module 1 of the present embodiment, structures such as the grip portion 21 and the leg portions 23 made of resins are provided on the lid portions 7. Thus, since the resin structures are not provided on the outer surfaces of the case body 5, it is possible to prevent heat dissipation characteristics of the battery cells 2 from being degraded due to the structures.

Although the details of the embodiment of the present invention have been described above, it should be understood that the present invention is not limited to the embodiment described above, and various modifications can be made without departing from the scope of the present invention.

In the power storage module according to the embodiment of the present invention, the number of partition wall 6 may be plural, for example. In this case, the plurality of partition walls 6 may be arranged at intervals in the stacking direction. In this configuration, the housing space 11 of the case body is partitioned into three or more separate spaces arranged in the stacking direction. Even in such a configuration, it is preferable that at least one partition wall 6 is positioned in the central portion of the case body 5 in the stacking direction (in the middle or near the middle of the housing space 11).

In addition, when the plurality of partition walls 6 are disposed in the central portion of the case body 5 in the stacking direction (in the middle or near the middle of the housing space 11), several cooling fins 9 positioned in the central portion among the plurality of cooling fins 9 arranged in the stacking direction may overlap the plurality of partition walls 6 disposed in the central portion, respectively, in the second orthogonal direction (thickness direction of the wall portions of the case body 5).

What is claimed is:

1. A power storage module comprising:
a plurality of battery cells stacked in one direction; and
a battery case which houses the plurality of battery cells,
wherein the battery case includes: a case body which is formed in a tubular shape having a first orthogonal direction orthogonal to a stacking direction of the plurality of battery cells as an axial direction of the case body, and of which an inside is a housing space that houses the plurality of battery cells; and a plurality of cooling fins which protrude from an outer surface of the case body and are arranged to be spaced apart in the stacking direction, and
protruding heights of the cooling fins become higher moving toward a center from both ends of the case body in the stacking direction.

2. A power storage module comprising:
a plurality of battery cells stacked in one direction; and
a battery case which houses the plurality of battery cells,
wherein the battery case includes: a case body which is formed in a tubular shape having a first orthogonal direction orthogonal to a stacking direction of the plurality of battery cells as an axial direction of the case body, and of which an inside is a housing space that houses the plurality of battery cells; and a plurality of cooling fins which protrude from an outer surface of the case body and are arranged to be spaced apart in the stacking direction, and
intervals between the cooling fins adjacent to each other in the stacking direction become smaller moving toward a center from both ends of the case body in the stacking direction.

3. The power storage module according to claim 1,
wherein the case body is formed in a rectangular tubular shape having a pair of first side walls disposed to be spaced apart in the stacking direction and a pair of second side walls disposed to be spaced apart in a second orthogonal direction orthogonal to the stacking direction and the first orthogonal direction, and
the plurality of cooling fins protrude from each of outer surfaces of the pair of second side walls and are arranged in the stacking direction on each of the pair of second side walls.

4. The power storage module according to claim 1,
wherein the battery case further includes a partition wall which is connected to an inner surface of the case body and partitions the housing space into a plurality of separate spaces arranged in the stacking direction,
the partition wall is disposed in a central portion of the case body in the stacking direction, and
at least one cooling fin of the plurality of cooling fins arranged in the stacking direction overlaps the partition wall in a second orthogonal direction orthogonal to the stacking direction and the first orthogonal direction.

5. The power storage module according to claim 4,
wherein the partition wall is formed to extend in the second orthogonal direction,
both ends of the partition wall in the second orthogonal direction are connected to the inner surface of the case body, and
a protruding height of the one cooling fin overlapping the partition wall is higher than a protruding height of another cooling fin adjacent to the one cooling fin in the stacking direction.

6. The power storage module according to claim 1,
wherein the battery case further includes a partition wall which is connected to an inner surface of the case body and partitions the housing space into a plurality of separate spaces arranged in the stacking direction,
the partition wall is formed to extend in a second orthogonal direction orthogonal to the stacking direction and the first orthogonal direction,
both ends of the partition wall in the second orthogonal direction are connected to an inner surface of the case body, and
a thickness of the cooling fin in the stacking direction is smaller than a thickness of the partition wall in the stacking direction.

7. The power storage module according to claim 1,
wherein the case body is formed in a square tubular shape having a pair of first side walls disposed to be spaced apart in the stacking direction and a pair of second side walls disposed to be spaced apart in a second orthogonal direction orthogonal to the stacking direction and the first orthogonal direction,
an inner surface of the first side wall facing an inside of the case body is formed to be a flat surface orthogonal to the stacking direction,
an inner surface of the second side wall facing an inside of the case body is formed to be a flat surface orthogonal to the second orthogonal direction,
the plurality of cooling fins protrude from each of outer surfaces of the pair of second side walls, and
a thickness in the second orthogonal direction obtained by summing thicknesses of the second side wall and the cooling fin provided on the second side wall is equal to or less than a thickness of the first side wall in the stacking direction.
